(19) United States
(12) Patent Application Publication
(10) Pub. No.: US 2019/0132411 A1
(43) Pub. Date: May 2, 2019

(54) METHOD AND SYSTEM FOR CACHE PLACEMENT OF BASE STATION AND A CORRESPONDING BASE STATION

(71) Applicant: INDUSTRIAL TECHNOLOGY RESEARCH INSTITUTE, Hsinchu (TW)

(72) Inventors: Hsuan-Jung SU, Taipei City (TW); Mu-Chi FANG, Taichung City (TW); Chia-Han LEE, Taipei City (TW); Jhe-Yi LIN, Kaohsiung City (TW)

(21) Appl. No.: 15/855,804

(22) Filed: Dec. 27, 2017

(30) Foreign Application Priority Data
Oct. 26, 2017 (TW) 106136986

(51) Int. Cl. H04L 29/08; H04W 64/00

(52) U.S. Cl. CPC H04L 67/2842; H04L 67/06; H04W 64/00

(57) ABSTRACT

A method and a system for cache placement of base station and a corresponding base station are provided. The method for cache placement of base station includes the following steps. A dynamic moving information of a mobile device is obtained. A popularity of a file is generated according to the dynamic traveling information of the mobile device. A cache placement of at least one base station is determined according to the popularity. The file is transmitted to the at least one base station according to the cache placement for downloading by the mobile device.

### CROSS-REFERENCE TO RELATED APPLICATION

This application claims priority to Taiwan Application Serial Number 106136986, filed Oct. 26, 2017, which is herein incorporated by reference.

### FIELD

The present disclosure relates to a method and a control system of cache placement, a method for controlling the base station to transmit file and the corresponding base station.

### BACKGROUND

The existing communication system includes several base stations. When a user in the service range of the base station sends a file download request by his mobile device, the base station requests the server for the file according to the file download request and downloads the file for the user. Then, the file is transmitted to the mobile device by the base station in wireless transmission, so that the user is able to use it.

The data transmission between the base station and the server consumes bandwidth of the network. The transmission between the base station and the mobile device consumes the wireless bandwidth. When there are many users in the service range of the base station and these users all send file download requests to the base station by their mobile devices, respectively, the base station has to download the requested files for these users from the server and transmits these files to these users through wireless transmission separately. Even if the requested files for these users are the same or similar, the base station downloads the files from the server whenever the base station receives the file download requests of the users. Downloading the files and transmitting the files to the mobile devices separately might consume more bandwidth than necessary.

Therefore, if a cache unit can be equipped at the base station, after downloading a file from the data server or the file provision server, the base station can store the file in the cache unit temporarily and the file is available for other users having the common request for it. Therefore, the network traffic can be reduced. Storing the file in the cache unit temporarily is called the cache placement.

Equipping cache units at the base station and storing data in the cache for possible future requests can reduce the number of downloading data from the server, so as to reduce bandwidth consumption of the network. However, the effect of reducing bandwidth consumption of the network is related to the cache placement. Accordingly, there is a trend to find methods to optimize the cache placement.

### SUMMARY

The present disclosure is related to a method and a control system of cache placement.

The first aspect of the present disclosure is related to a method of cache placement for base station. The method includes the following steps. A dynamic moving information of a mobile device is obtained. A popularity of a file is determined according to the dynamic moving information of the mobile device. A cache placement of at least one base station is determined according to the popularity. The file is transmitted to the at least one base station according to the cache placement for the mobile device to download.

The second aspect of the present disclosure is related to a control system of cache placement for base station. The control system includes a popularity generator, a cache placement decision unit, and a cache update controller. The popularity generator is configured for obtaining a dynamic moving information of a mobile device and determining a popularity of a file according to the dynamic moving information of the mobile device. The cache placement decision unit is configured for determining a cache placement of at least one base station according to the popularity. The cache update controller is configured for transmitting the file to the at least one base station according to the cache placement for the mobile device to download.

The third aspect of the present disclosure is related to a method of cache placement for base station. The method includes the following steps. A cache placement is received, in which the cache placement is generated according to a dynamic moving information of a mobile device. At least one cache file is downloaded according to the cache placement. The at least one cache file is stored in a cache unit of the base station. A first file download request is received. A file transmission is performed in a first transmission mode or a second transmission mode according to the first file download request and a cache state of the cache unit.

The fourth aspect of the present disclosure is related to a base station. The base station includes a receiving unit, a download unit, a cache unit, and a transmission unit. The receiving unit is configured for receiving a cache placement and a first file download request, in which the cache placement is generated according to a dynamic moving information of a mobile device. The download unit is configured for downloading at least one cache file according to the cache placement. The cache unit is configured for storing the at least one cache file. The transmission unit performs a file transmission in a first transmission mode or a second transmission mode according to the first file download request and a cache state of the cache unit.

### BRIEF DESCRIPTION OF THE DRAWINGS

FIG. 1 is a schematic diagram of a communication system according to one embodiment of the present disclosure.

FIG. 2 is a schematic diagram of a connection between a central unit and a base station according to one embodiment of the present disclosure.

FIG. 3A is a flowchart of a method of cache placement according to one embodiment of the present disclosure.

FIG. 3B is a flowchart of a method of cache placement according to another embodiment of the present disclosure.

FIG. 4 is a flowchart of a method of cache placement according to another embodiment of the present disclosure.

FIG. 5A is a flowchart of a method for controlling base station to transmit file according to one embodiment of the present disclosure.

FIG. 5B is a flowchart of a method for controlling base station to transmit file according to another embodiment of the present disclosure.

### DETAILED DESCRIPTION OF DISCLOSED EMBODIMENTS

Reference will now be made in detail to the present embodiments of the disclosure, examples of which are illustrated in the accompanying drawings. Wherever possible, the same reference numbers are used in the drawings and the description to refer to the same or like parts.

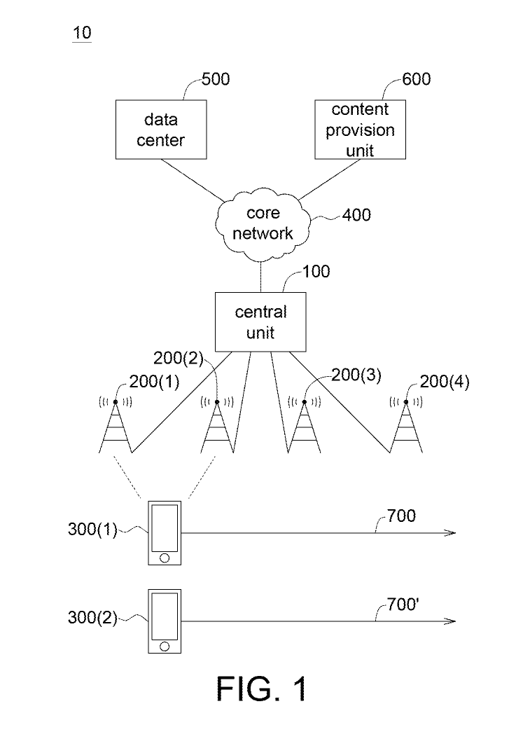

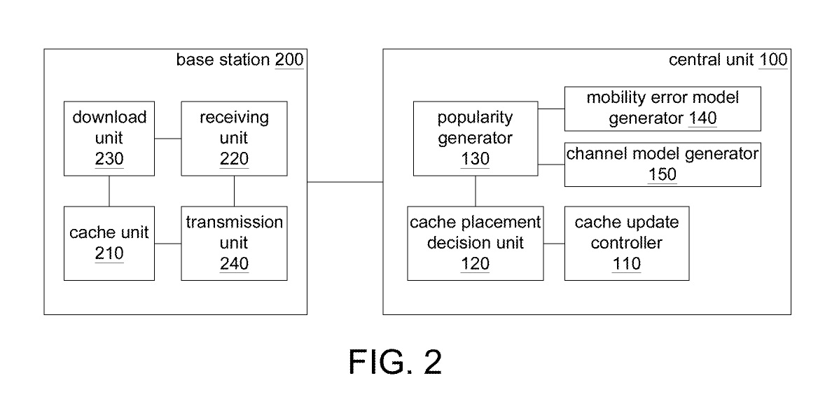

Reference is made to FIG. 1 and FIG. 2. FIG. 1 is a schematic diagram of a communication system 10 according to one embodiment of the present disclosure. FIG. 2 is a schematic diagram of a connection between a central unit 100 and a base station 200 according to one embodiment of the present disclosure. The communication system 10 includes a central unit 100, at least one base station 200, at least one mobile device 300, a core network 400, a data center 500, and a content provision unit 600. The central unit 100, the data center 500, and content provision unit 600 are able to connect to the core network 400 in wired connection or wireless connection. The content provision unit 600 is able to provide the file data, such as music, photograph, video, application, etc., to the base station 200 and the mobile devices 300 that are coupled to the core network 400. The aforementioned data center 500 and/or the aforementioned content provision unit 600 may be personal computer, server system, but it is not limited thereto. In the present embodiment, the data center 500 and the content provision unit 600 are assembled in two different servers, but it is not limited thereto. The data center 500 and the content provision unit 600 are able to be assembled in the same server, too.

The central unit 100 includes a cache update controller 110, a cache placement decision unit 120, a popularity generator 130, a mobility error model generator 140, and a channel model generator 150. The cache update controller 110 is coupled to the cache placement decision unit 120. The cache placement decision unit 120, the mobility error model generator 140, and the channel model generator 150 are coupled to the popularity generator 130. The central unit 100, the cache update controller 110, the cache placement decision unit 120, the popularity generator 130, the mobility error model generator 140, and the channel model generator 150 are able to be implemented by, for example, a chip, a circuit block in a chip, a firmware circuit, a circuit board with several electronic components and wires, or a storage medium stored with several program codes. They are able to be implemented by performing corresponding software or program on the electronic devices such as computer system or server, too.

The central unit 100 is able to connect to and transmit file to several base stations 200 in wired connection or wireless connection. Several base stations 200 include, for example, base stations 200 (1), 200 (2), 200 (3), and 200 (4). Although the present embodiment takes the base stations 200 including the base stations 200 (1), 200 (2), 200 (3), and 200 (4) as an example, the base stations 200 may include more or less base stations. Each of the base stations 200 includes a cache unit 210, a receiving unit 220, a download unit 230, and a transmission unit 240. Each of the base stations 200 is able to communicate with and transmit file to the mobile devices 300 by its antenna (not shown in the figure) in wireless connection. Although the present embodiment takes the mobile devices 300 including the mobile devices 300 (1) and 300 (2) as an example, the mobile devices 300 may include one or more mobile devices. The mobile device 300 (1) moves along a route 700. The mobile device 300 (2) moves along a route 700′. In one embodiment, the route 700 is the same as the route 700′. In another embodiment, the route 700 is different from the route 700′. The cache unit 210, the receiving unit 220, the download unit 230, and the transmission unit 240 are able to be implemented by, for example, a chip, a circuit block in a chip, a firmware circuit, a circuit board with several electronic components and wires, or a storage medium stored with several program codes. They are able to be implemented by performing corresponding software or program on the electronic devices such as computer system or server, too.

The aforementioned wired connection may be by, for example, Ethernet or optical fiber cable, but it is not limited thereto. Any connection between nodes by cable is available. The aforementioned wireless connection may be, for example, Code Division Multiple Access (CDMA) 2000, General Packet Radio Service (GPRS), Global System for Mobile Communications (GSM), Long Term Evolution (LTE), LTE Advanced, or Worldwide Interoperability for Microwave Access (WiMax), but it is not limited thereto. Any connection between nodes without cable is available.

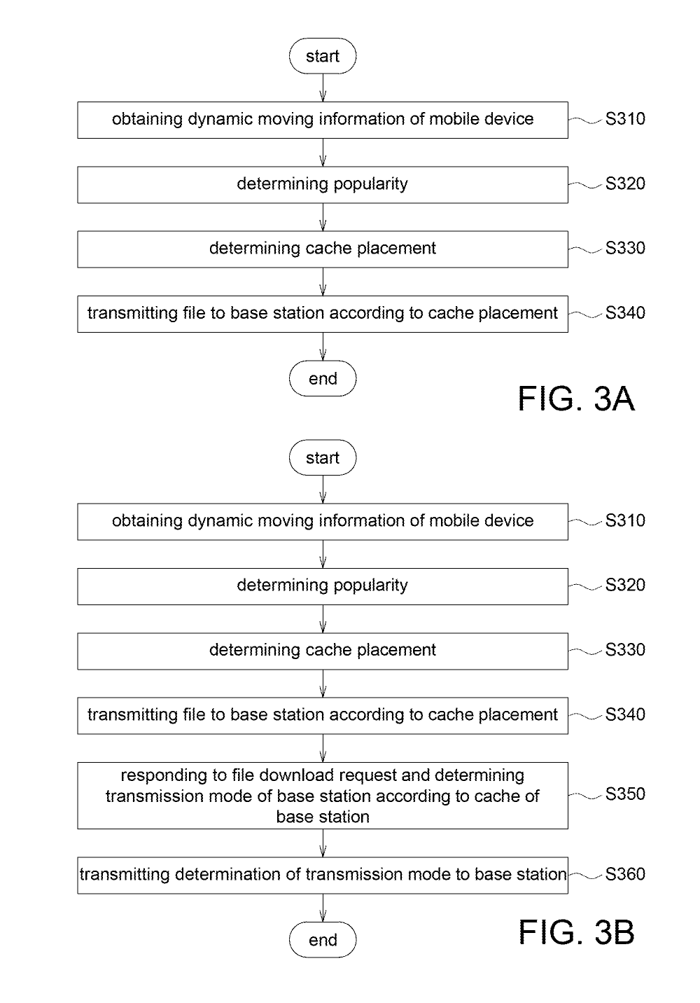

Reference is made to FIG. 3A. FIG. 3A is a flowchart of a method of cache placement according to one embodiment of the present disclosure. The method of cache placement shown in FIG. 3A is able to apply in, for example, the central unit 100 of the communication system 10 shown in FIG. 1 or the central unit 100 shown in FIG. 2. In order to clearly describe the operation of the aforementioned components and the method of cache placement in the present embodiment, they will be clearly described with the flowchart of FIG. 3A as below. However, one of ordinary skill in the art would appreciate that the method of cache placement in the present embodiment is not limited in the communication system 10 in FIG. 1 and the central unit 100 and the base station 200 in FIG. 2, and is not limited in the order of the steps in the flowchart of FIG. 3A, too.

According to one embodiment of the present disclosure, at first, in the step S310, the mobility error model generator 140 of the central unit 100 obtains a dynamic moving information of the mobile device 300 (1). The aforementioned dynamic moving information, which is a predicable moving route of a mobile device, includes one or more known mobile device routes. For example, the known mobile device route may be the moving path of high-speed rail, the travel route of bus, or the planning travel path of taxi in which the destination is determined. For example, after the user of the mobile device 300 (1) takes on the high-speed rail, the mobility error model generator 140 is able to realize the next probable moving route of the mobile device 300 (1), such as the travel route of the high-speed rail. Therefore, the mobility error model generator 140 is able to realize which base stations that the mobile device 300 (1) would pass through subsequently according to the base stations corresponding to the travel route of the high-speed route, and to obtain the probabilities of the service cells of these base stations that the mobile device 300 (1) would pass through. For example, after the mobility error generator 140 obtains the dynamic moving information of the mobile device 300 (1), it is capable of obtaining a dynamic moving probability that the mobile device 300 (1) occurs at a specific location in this moving route. In another embodiment of the present disclosure, the mobility error model generator 140 of the central unit 100 is able to obtain the dynamic moving information of several mobile devices, for example, the dynamic moving information of the mobile devices 300 (1) and 300(2.)

Next, in the step S320, the popularity generator 130 determines a popularity of a file according to the dynamic moving information of the mobile device 300 (1). For example, the aforementioned popularity is generated according to the dynamic moving information of the mobile device 300 (1) and one or more file download requests sent from the user of the mobile device 300 (1). In other words, when the user of the mobile device 300 (1) wants to download a specific file (or a specific data segment) or watch/listen to a specific video/audio stream, e.g., an audio file, a video file, or the data segment of these files, the user operates the mobile device 300 (1) to send the file download request for this file and indicates the mobile device 300 (1) to download the requested file or data segment. It is understood that the number of the aforementioned file or data segment may be one or more. The one or more files or data segments include an original popularity. The original popularity is related to, for example, the number of downloading the file by other users. Comparing with the original popularity, the aforementioned popularity may be regarded as another popularity adapted for the present embodiment. The aforementioned popularity is able to be generated according to the dynamic moving information of the mobile device 300 (1) and the probability that the mobile device 300 (1) downloads the aforementioned file in at least one service cell corresponding to the base station 200 (e.g., the base stations 200 (1)-200(4)). In other words, the aforementioned popularity is generated according to the dynamic moving probability that the mobile device 300 (1) occurs at a specific location in the moving route (e.g., the probability that the mobile device 300 (1) moves to a specific location or a coverage area corresponding to a specific base station in a specific period, and this probability is able to be obtained by route prediction computation) and the probability that the mobile device 300 (1) downloads the aforementioned file in at least one service cell corresponding to the base station 200. For example, the popularity may be the product of the dynamic moving probability and the probability of downloading the aforementioned file, or other arithmetic values.

Next, in the step S330, the cache placement decision unit 120 determines a cache placement of the base station 200 according to the popularity. The aforementioned cache placement of the base station 200 is configured for determining which file/files (or data segment) would be stored in the cache unit 210 of the base station 200 (one or more base stations). In the step S340, the cache update controller 110 transmits the file, which should be stored in the base station 200 (one or more base stations), to the cache unit 210 of the base station 200 (one or more base stations) for the mobile device 300 (1) to download. For example, it determines which file/files or the data segment are downloaded to at least one of the base stations 200 (1)-200 (4), and the at least one of the base stations is the base station corresponding to the service cell that the mobile device 300 (1) probably passes through, in which the service cell is corresponding to the predicted route of the mobile device 300 (1).

The cache placement mechanism is able to determine which file or data segment would be stored in the cache unit of several base stations based on the original popularity of the files or the data segment. In one embodiment, the cache placement mechanism calculates the popularity based on both the probability that one base station or some base stations download the file or the data segment indicated by the file download request (similar to the original popularity) and the dynamic moving information of the mobile device 300 (1) (including the probability of arrival at one base station or some base stations). According to the popularity, the cache placement is performed so as to determine which one base station or some base stations should download which file or data segment previously. Therefore, when the user moves to one base station or some base stations, the user is able to download the necessary file or data segment quickly, rather than waiting one base station or some base stations to re-download this file or data segment. Accordingly, the occupied network resource necessary for one base station or some base stations to re-download one file or one data segment is also reduced, so that the data flow between the base station 200 and the central unit 100, or between the central unit 100, core network 400, the data center 500, and the content provision unit 600 is reduced.

Reference is made to FIG. 3B. FIG. 3B is a flowchart of a method of cache placement according to another embodiment of the present disclosure. The method of cache placement shown in FIG. 3B is able to apply in, for example, the central unit 100 of the communication system 10 shown in FIG. 1 or the central unit 100 shown in FIG. 2. One of ordinary skill in the art would appreciate that the method of cache placement in the present embodiment is not limited in the communication system 10 in FIG. 1 and the central unit 100 and the base station 200 in FIG. 2, and is not limited in the order of the steps in the flowchart of FIG. 3B, too. In the embodiment shown in FIG. 3B, the steps S310, S320, S330, and S340 are the same as or similar to the steps S310, S320, S330, and S340 of the embodiment in FIG. 3A, and thus no further description will be given herein. Comparing with FIG. 3A, the method of cache placement in the present embodiment further selectively includes the step S350 and the step S360 shown in FIG. 3B.

In the step S350, the cache update controller 110 responds to the file download request of the mobile device 300 (1), and according to the cache state of the base station 200 (one or more base stations), it determines the transmission mode of the base station 200 (one or more base stations) to the mobile device 300 (1), i.e., it determines the transmission mode between the base station 200 (one or more base stations) and the mobile device 300 (1). In the step S360, the cache update controller 110 transmits the determined transmission mode to the base station 200. Therefore, the base station 200 is able to respond to the file download request of the mobile device 300 (1) according to the aforementioned determined transmission mode, and transmit the file to the mobile device 300 (1). In other words, the cache update controller 110 is able to transmit a transmission mode control signal to the base station 200. The base station 200 performs a file transmission according to the transmission mode control signal and the transmission mode determined by the central unit 100, and transmits the file to the mobile device 300 (1).

The aforementioned transmission mode may be one of a joint transmission mode and a coordinated beamforming mode. In one embodiment, when the cache states of at least two base stations corresponding to a current location of the mobile device show that the at least two base stations store the file, the transmission mode is the joint transmission mode. Otherwise, the file is transmitted to the mobile device by the single base station, and the transmission mode is the coordinated beamforming mode. The base station is able to respond to the file download requests of different mobile devices in different transmission modes, and different transmission modes are adopted between the base station and different mobile devices. In one embodiment of the present disclosure, one or more base stations are able to use the combination of the aforementioned transmission modes simultaneously to respond to the file download requests of different mobile devices in a specific area with at least one mobile device.

For example, it is supposed that the mobile device 300 (1) is located in the service cells of the base station 200 (1) and the base station 200 (2), the cache update controller 110 would check the cache states of the base station 200 (1) and the base station 200 (2), so as to determine the transmission modes between the base station 200 (1) and the base station 200 (2) and the mobile device 300 (1). The cache state is, for example, the state showing whether the file or the data segment indicated by the file download request are stored in the cache units of the base station 200 (1) and the base station 200 (2) or not. When the cache states of the base station 200 (1) and the base station 200 (2) corresponding to the current location of the mobile device 300 (1) show that both the base station 200 (1) and the base station 200 (2) store this file or data segment, the cache update controller 110 determines that the transmission mode between the base station 200 (1) and the base station 200 (2) and the mobile device 300 (1) is the joint transmission mode and controls the base station 200 (1) and the base station 200 (2) to transmit the file or data segment necessary to be transmitted to the mobile device 300 (1) together. If only one of the base station 200 (1) and the base station 200 (2) stores this file or data segment, the cache update controller 110 determines that the transmission mode between one of the base station 200 (1) and the base station 200 (2) stored with this file or data segment and the mobile device 300 (1) is the coordinated beamforming mode and controls the one of the base station 200 (1) and the base station 200 (2) stored with this file or data segment to transmit the file or data segment to the mobile device 300 (1) alone.

For example, it is supposed that the mobile device 300 (1) and the mobile device 300 (2) are located in the service cells of the base station 200 (1) and the base station 200 (2), the cache update controller 110 would check the cache states of the base station 200 (1) and the base station 200 (2), so as to determine the transmission mode between the base station 200 (1) and the base station 200 (2) and the mobile device 300 (1) and the transmission mode between the base station 200 (1) and the base station 200 (2) and the mobile device 300 (2). The transmission mode between the mobile device 300 (1) and the base station 200 is able to be different from the transmission mode between the mobile device 300 (2) and the base station 200. The transmission mode between the mobile device 300 (1) and the base station 200 is able to be the same as the transmission mode between the mobile device 300 (2) and the base station 200, too.

In another embodiment of the present disclosure, the popularity generator 130 is further able to obtain a transmission channel state information of the base station 200 corresponding to the dynamic moving information of the mobile device 300 (1). In one embodiment, the popularity is able to be generated according to the dynamic moving information of the mobile device 300 (1) and the probability that the mobile device 300 (1) downloads the aforementioned file in at least one service cell corresponding to the base station 200. In one embodiment, the popularity generator 130 is able to generate the popularity of a file or data segment according to the dynamic moving information of the mobile device 300 (1) and the transmission channel state information of the base station 200 corresponding to the dynamic moving information of the mobile device 300 (1). In another embodiment, the popularity generator 130 is able to generate the popularity according to the dynamic moving information of the mobile device 300 (1), the probability that the mobile device 300 (1) downloads the aforementioned file in at least one service cell corresponding to the base station 200, and/or the transmission channel state information of the base station 200 corresponding to the dynamic moving information of the mobile device 300 (1).

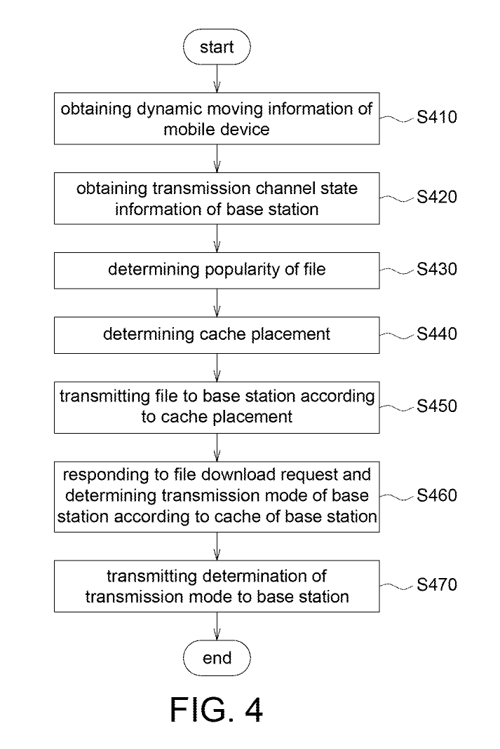

Reference is made to FIG. 4. FIG. 4 is a flowchart of a method of cache placement according to another embodiment of the present disclosure. The method of cache placement shown in FIG. 4 is able to apply in the communication system 10 shown in FIG. 1 and the central unit 100 and the base station 200 shown in FIG. 2.

At first, in the step S410, the mobility error model generator 140 of the central unit 100 obtains a dynamic moving information of the mobile device 300 (1). The aforementioned dynamic moving information is the same as the dynamic moving information described in the aforementioned embodiment, and thus no further description will be given herein.

Next, in the step S420, the channel model generator 150 obtains a transmission channel state information 200 (e.g., the base stations 200 (1)-200 (4)) of at least one base station corresponding to the dynamic moving information of the mobile device 300 (1). The state of the transmission channel may be affected by geographical environment (e.g., in the tunnel or near the mountain) and the location of the base station itself. The aforementioned transmission channel state information is, for example, the static data of the channel state modular data of when at least one base station transmits data previously at a specific location in the moving route of the mobile device 300 (1). The aforementioned transmission channel state information is, for example, the data of the channel state of when at least one base station predicts to transmit data at a specific location in the moving route of the mobile device 300 (1). The transmission channel state information may be the past or predicted channel state in the moving route of the mobile device 300 (1).

In the step S430, the popularity generator 130 determines the popularity of a file or data segment according to the dynamic moving information of the mobile device 300 (1) and the transmission channel state information of the base station 200 corresponding to the dynamic moving information of the mobile device 300 (1). It is understood that the number of the file or data segment may be one or more. For example, the aforementioned popularity is able to be generated according to the dynamic moving information of the mobile device 300 (1), the transmission channel state information of the base station 200, and a file download request (configured for indicating which one or more files or data segments would be downloaded) sent from the mobile device 300 (1) by the user. For example, the aforementioned popularity is able to be generated according to the dynamic moving probability that the mobile device 300 (1) occurs at a specific location in the moving route, the condition of the past or predicted channel transmission of each base station in the moving route of the mobile device 300 (1), and the probability that the mobile device 300 (1) downloads the aforementioned file or data segment in at least one service cell corresponding to the base station 200. For example, the popularity may be the product or other arithmetic result of the aforementioned dynamic moving probability, the transmission channel state information and the probability of downloading the aforementioned file.

The probability of downloading the file is not only related to the requirement of the user, but also related to the past or predicted channel state of the moving route of the mobile device. For example, the video/audio stream has continuity. The mobile device may download the subsequent video/audio segment to its buffer previously when the channel state is good, so as to affect the probability of downloading the specific file segment in the moving route of the mobile device.

Since the geographical environment near by the base station rarely varies a lot in a short period, it is able to adopt the transmission channel state information while performing the cache placement to obtain better result of the cache placement. For example, if the past channel state of a specific base station is poor, it is able to consider to download the wanted file or data segment to this base station previously so that the mobile device 300 (1) is able to obtain this file or data segment successfully while the mobile device 300 (1) advances on the service cell of this base station, and the condition that the transmission rate is slowed down due to the poor channel state or the condition of waiting too long due to long download time can be improved. For example, it is supposed that the mobile device 300 (1) includes the cache unit for storing the cache data. Before the mobile device 300 (1) enters the service cell of one base station with poor past or predicted channel state, i.e., before the mobile device 300 (1) enters the service cell in which the transmission channel state information indicates that the past or predicted channel or network environment is poor, it is further able to transmit the requested file or data segment to the cache unit of the mobile device 300 (1) via push notification mechanism.

Next, in the step S440, the cache placement decision unit 120 determines a cache placement of the base station 200 according to the base station 200. The aforementioned determination of the cache placement of the base station (one or more base stations) is determining which file or data segment should be stored in the cache unit 210 of the base station 200 (one or more base stations). In the step S450, the cache update controller 110 transmits the file or data segment, which should be stored in the base station 200 (one or more base stations), to the cache unit 210 of the base station 200 for the mobile device 300 (1) to download.

In the step S460, the cache update controller 110 responds to the file download request of the mobile device 300 (1), and according to the cache state of the base station 200 (one or more base stations), it determines the transmission mode of the base station 200 to the mobile device 300 (1), i.e., it determines the transmission mode between the base station 200 and the mobile device 300 (1). After the transmission mode is determined, in the step S470, the cache update controller 110 transmits the determined transmission mode to the base station 200. Therefore, the base station 200 is able to respond to the file download request of the mobile device 300 (1) according to the aforementioned determined transmission mode, and transmit the file to the mobile device 300 (1). In other words, the cache update controller 110 is able to transmit a transmission mode control signal to the base station 200. The base station 200 performs a file transmission according to the transmission mode control signal and the transmission mode determined by the central unit 100, and transmits the file to the mobile device 300 (1).

The aforementioned transmission mode may be one of a joint transmission mode and a coordinated beamforming mode. When the cache states of at least two base stations 200 corresponding to a current location of the mobile device 300 (1) show that the at least two base stations store the same file (e.g., the cache unit of the base station stores the file or data segment indicated by the file download request), the at least two base stations 200 are able to transmit the file to the mobile device 300 (1) in the joint transmission mode. However, when the cache placement of the base station 200 fails to comply with the file download request of the mobile device 300 (1) (e.g., the corresponding cache unit of the base station does not store the file or data segment indicated by the file download request), the central unit 100 downloads the file or data segment indicated by the file download request (which is able to be viewed as a new file) from the data center 500 or the content provision unit 600 since the cache placement of the base station 200 fails to comply with the file download request of the mobile device 300 (1), and transmits this new file to at least one base station 200. Therefore, at least one base station 200 receives the determined transmission mode and downloads this new file at the same time. Then, at least one base station 200 performs a file transmission according to the transmission mode determined by the central unit 100, and transmits this new file to the mobile device 300 (1).

In one embodiment, if the popularity of the new file is greater than the popularity of the file originally stored in the base station 200 (one or more base stations), then the new file is stored in the cache unit 210 of the base station 200 (one or more base stations), it updates and replaces the file stored in the cache unit 210 of the base station 200 (one or more base stations) with the new file. In another embodiment, if the popularity of the aforementioned new file is not greater than the popularity of the file originally stored in the base station 200 (one or more base stations) and the storage space of the cache unit 210 is not full, then the new file is stored in the cache unit 210 of the base station 200 (one or more base stations). In another embodiment, the popularity of the aforementioned new file is not greater than the popularity of the file originally stored in the base station 200 (one or more base stations) and the storage space of the cache unit 210 is full, then the base station 200 does not store the new file. In other words, although the base station downloads the new file, it does not necessarily to update or replace the data originally stored in the cache unit 210 with the new file.

In one embodiment, there are the mobile device 300 (1) and the mobile device 300 (2) in the service cells of the base station 200 (1) and the base station 200 (2). The transmission mode between the mobile device 300 (1) and the base station 200 is determined according to whether the file or data segment indicated by the file download request of the mobile device 300 (1) is stored in the cache units 210 of the base station 200 (1) and the base station 200 (2). The transmission mode between the mobile device 300 (2) and the base station 200 is able to be the same as the transmission mode between the mobile device 300 (1) and the base station 200. The transmission mode between the mobile device 300 (2) and the base station 200 is able to be different from the transmission mode between the mobile device 300 (1) and the base station 200, too.

The methods for determining the cache placement in the aforementioned steps S330 and S340 are described exemplarily as below. At first, the probability that each file (or data segment) in the data center 500, the content provision unit 600, and/or the cache unit 210 of the base station 200 requested to download by one or more mobile devices is obtained. Next, the files (or data segments) are selected which having the probability that the mobile device requests to download greater than a download probability threshold value. Next, the files (or data segments) with the requested download probability greater than the download probability threshold value are integrated into the cache placement, and the sum of the file sizes of these files (or data segments) are taken as the file size of the cache placement. The files (or data segments) requested to download by one or more mobile devices may not exist in the cache unit 210 of the base station 200 originally, but they are able to be integrated into the cache placement and stored in the cache unit or substituted for the partial files (or data segments) originally stored in the cache unit since the requested download probability is greater than the download probability threshold value.

Since the storable space of the cache unit 210 of the base station 200 is limited, the base stations 200 of which the cache units 210 that is not enough to store the cache placement are marked and recorded when the cache unit 210 of the base station 200 is not enough to store the cache placement, i.e., the file size of the cache placement is greater than the storable space of the cache unit 210 of the base station 200. Subsequently, the cache placements corresponding to these base stations 200 are adjusted.

The process of adjusting the cache placement of the base station 200 is to select one file (or data segment) in the cache placement from the files of which the cache placement is composed, and remove the selected file (or data segment) from the cache placement, so as to reduce the file size of the cache placement. Next, the greatest expression value, which the cache placement would reach after removing the file, is calculated. For example, it is able to use Markov Decision Process to calculate the aforementioned greatest expression value.

Each of the greatest expression values of all files (or data segments) in the cache placement with removed one in order is calculated, respectively, and these greatest expression values are able to arranged in the degressive order. Next, the file (or data segment) corresponding to the maximum of these greatest expression values is removed from the cache placement, and the cache placement of the base station 200 is updated. The aforementioned determination of the cache placement is exemplary embodiment, and it is not limited thereto. Any adjustment of the file size of the cache placement is available.

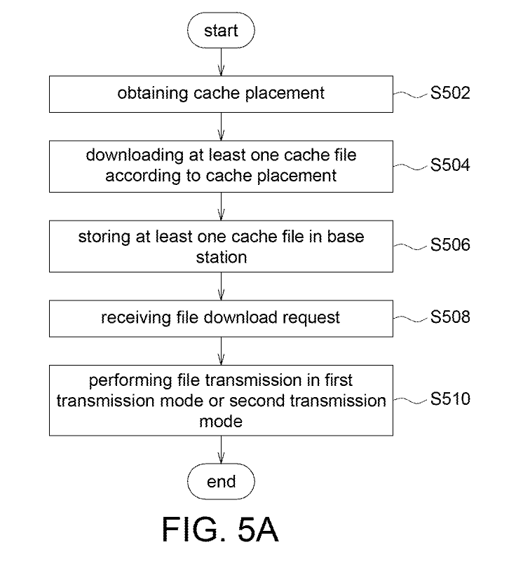

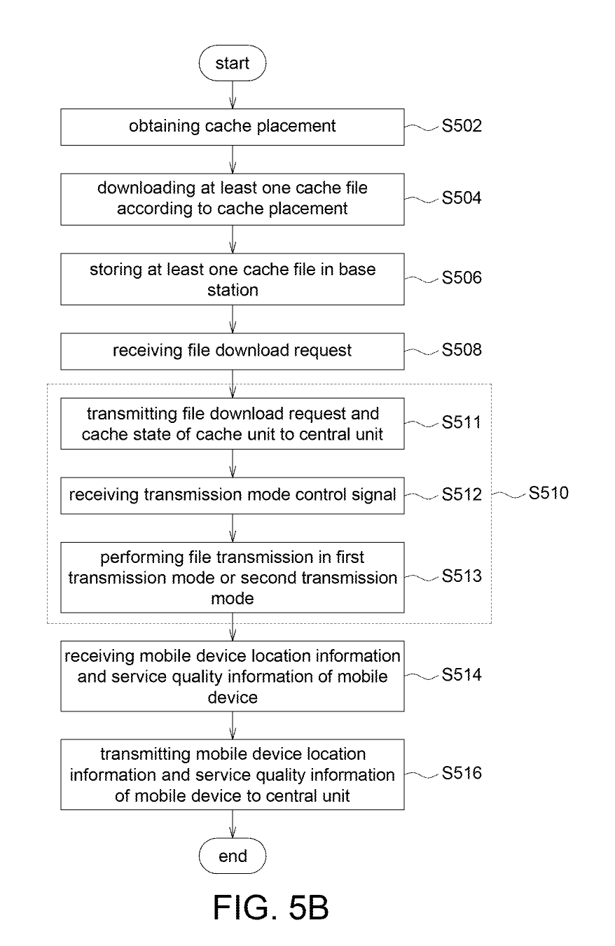

Reference is made to FIG. 5A. FIG. 5A is a flowchart of a method for controlling base station to transmit file according to one embodiment of the present disclosure. The method for controlling base station to transmit file shown in FIG. 5A is able to apply in, for example, the base station 200 of the communication system 10 shown in FIG. 1 or the base station 200 shown in FIG. 2. In order to clearly describe the operation of the aforementioned components and the method for controlling base station to transmit file in the present embodiment, they will be clearly described with the flowchart of FIG. 5A as below. However, one of ordinary skill in the art would appreciate that the method for controlling base station to transmit file in the present embodiment is not limited in the communication system 10 in FIG. 1 and the central unit 100 and the base station 200 in FIG. 2, and is not limited in the order of the steps in the flowchart of FIG. 5A, too.

In the step S502, the receiving unit 220 of the base station 200 is able to receive a cache placement from the central unit 220. For example, this cache placement is able to be generated according to a dynamic moving information of the mobile device 300 (1). For example, this cache placement is able to be generated according to the dynamic moving information of the mobile device 300 (1) and/or the transmission channel state information of the base station. The aforementioned embodiment has described exemplarily how to determine the cache placement and thus no further description will be given therein.

In the step 504, the download unit 230 of the base station 200 is able to download one or more cache files from the central unit 100 according to this cache placement. In the step S506, the cache file downloaded from the central unit 100 is stored in the cache unit 210 of the base station 200. Next, in the step S508, the receiving unit 220 receives the file download request of the mobile device 300 (1). Subsequently, in the step S510, the transmission unit 240 of the base station 200 performs a file transmission in a first transmission mode or a second transmission mode according to the file download request and a cache state of the cache unit 210.

In other word, the base station 200 transmits the file to the mobile device 300 (1) in the first transmission mode or the second transmission mode. In one embodiment, the first transmission mode is the joint transmission mode, and the second transmission mode is the coordinated beamforming mode. In one embodiment, if the cache file complies with the file or data segment requested to download by the file download request and the cache unit of other base station 200 also store this file or data segment, the transmission unit 240 is able to cooperate with other base station 200 to transmit the cache file (i.e., the file or data segment requested to download by the mobile device 300 (1)) stored in the cache unit 210 to the mobile device 300 (1) together in the joint transmission mode. If the cache file does not comply with the file or data segment requested to download by the file download request, the download unit 230 downloads a new file (or data segment) from the central unit 100 and the transmission unit 240 transmits this new file (or data segment) to the mobile device 300 (1) in the first transmission mode or the second transmission mode. In one embodiment, the central unit 100 is able to transmit the new file (or data segment) to at least two base stations corresponding to the area that the mobile device is located at, the at least two base stations are able to transmit the new file (or data segment) to the mobile device 300 (1) in the joint transmission mode. In another embodiment, the transmission unit 240 transmits the new file (or data segment) to the mobile device 300 (1) in the coordinated beamforming mode. In other words, this base station 200 transmits another new downloaded file or data segment to the mobile device 300 (1) alone. In one embodiment, the transmission mode between the mobile device 300 (2) and the base station 200 is able to be different from the transmission mode between the mobile device 300 (1) and the base station 200. In another embodiment, the transmission mode between the mobile device 300 (2) and the base station 200 is able to be the same as the transmission mode between the mobile device 300 (1) and the base station 200.

Reference is made to FIG. 5B. FIG. 5B is a flowchart of a method for controlling base station to transmit file according to another embodiment of the present disclosure. The method for controlling base station to transmit file shown in FIG. 5B is able to apply in, for example, the base station 200 of the communication system 10 shown in FIG. 1 or the base station 200 shown in FIG. 2. One of ordinary skill in the art would appreciate that the method for controlling base station to transmit file in the present embodiment is not limited in the communication system 10 in FIG. 1 and the central unit 100 and the base station 200 in FIG. 2, and is not limited in the order of the steps in the flowchart of FIG. 5B, too. In the embodiment shown in FIG. 5B, the steps S502, S504, S506, S508, and S510 are the same as or similar to the steps S502, S504, S506, S508, and S510 of the embodiment in FIG. 5A, and thus no further description will be given herein. The method for controlling base station to transmit file in the present embodiment further selectively includes the step S514 and the step S516 shown in FIG. 5B, and the step S510 further includes the steps S511-S513.

In the present embodiment, in the step S510, the transmission unit 240 performs the file transmission in the first transmission mode or the second transmission mode according to the file download request and the cache state of the cache unit 210, in which the step S510 includes the steps S511-S513. In the step S511, the transmission unit 240 of the base station 200 transmits the file download request and the cache state of the cache unit 210 to the central unit 100. For example, the central unit 100 is able to determine whether the cache file of the cache unit 210 complies with the file or data segment requested to download by the file download request of the mobile device 300 (1), so as to determine the transmission mode of the file and transmits a transmission mode control signal to the base station 200. In other words, the transmission mode control signal is determined and generated by the central unit 100 according to the file download request and the cache state of the cache unit 210. In another embodiment, the base station 200 is able to determine whether the cache file complies with the file or data segment requested to download by the file download request of itself, so as to determine the transmission mode of the file.

In the step S512, the receiving unit 220 receives the transmission mode control signal from the central unit 100. In the step S513, the transmission unit 240 performs the file transmission in the first transmission mode or the second transmission mode according to the transmission mode control signal.

After the transmission mode of the cache file is determined and the file is transmitted to the mobile device 300 (1) in the first transmission mode or the second transmission mode (the step S513), in the step S514, the receiving unit 220 receives a mobile device location information of the mobile device 300 (1) and a service quality information fed back by the mobile device 300 (1). The service quality information is information such as the connection quality and the delay during the period that the base station 200 transmits the file to the mobile device 300 (1). In the step S516, the transmission unit 240 transmits the mobile device location information and the service quality information to the central unit 100. The central unit 100 is able to update the dynamic moving information of the mobile device 300 (1) according to the mobile device location information, i.e., updating the location information of the mobile device 300 (1).

According to some embodiments of the present disclosure, a method and a control system of cache placement which combines dynamic information (e.g., the user moving route) and statistic information (e.g., the statistics of the file download requests of the users), considers the coordinated multi-point transmission, sets the cache of the base stations along one or more user moving routes to increase the probability that the coordinate multi-point transmission is implemented among the base stations along the user moving routes, decrease the backhaul bandwidth consumption, and increase the transmission capacity at the same time to ensure the quality of file transmission while the user moves.

According to the user moving route, the request of the user for the file, the consideration of the channel environment information into the cache placement given by the present disclosure, the hitting probability of the cache is enhanced, and the backhaul network problem of the joint transmission is reduced. Therefore, the goals of optimizing the management of physical layer, enhancing the quality of receiving signal by the user, adjusting the framework and the backhaul network, and reducing the average and peak of Internet traffic is achieved.

Although the present disclosure has been described in considerable detail with reference to certain embodiments thereof, other embodiments are possible. Therefore, the scope of the appended claims should not be limited to the description of the embodiments contained herein.

What is claimed is:

1. A method for cache placement of base station, comprising:
obtaining a dynamic moving information of a mobile device;
determining a popularity of a file according to the dynamic moving information of the mobile device;
determining a cache placement of at least one base station according to the popularity; and
transmitting the file to the at least one base station according to cache placement for the mobile device to download.

2. The method of claim 1, further comprising:
obtaining a transmission channel state information of the at least one base station corresponding to the dynamic moving information of the mobile device;
wherein the step of determining the popularity of the file comprises:
determining the popularity of the file according to the dynamic moving information of the mobile device and the transmission channel state information of the at least one base station.

3. The method of claim 2, further comprising:
according to the dynamic moving information of the mobile device and the transmission channel state information of the at least one base station, transmitting the file to a cache unit of the mobile device before the mobile device enters a service cell with poor channel or poor network environment indicated by the transmission channel state information.

4. The method of claim 1, wherein the dynamic moving information comprises a known mobile device route.

5. The method of claim 1, wherein the step of determining the popularity of the file comprises:
determining the popularity according to the dynamic moving information of the mobile device and a probability that the mobile device downloads the file in at least one service cell corresponding to the at least one base station.

6. The method of claim 1, further comprising:
responding to a first file download request of the mobile device, and determining a first transmission mode of the at least one base station to the mobile device according to a cache state of the at least one base station, wherein the at least one base station transmits the file to the mobile device in the first transmission mode.

7. The method of claim 6, wherein the first transmission mode is one of a joint transmission mode and a coordinated beamforming mode, wherein when the cache states of the at least two base stations corresponding to a current location of the mobile device show that the at least two base stations store the file, the first transmission mode is the joint transmission mode.

8. The method of claim 6, further comprising:
responding to a second file download request of another mobile device, and determining a second transmission mode of the at least one base station to the another mobile device according to the cache state of the at least one base station, wherein the at least one base station transmits the file to the another mobile device in the second transmission mode;
wherein the second transmission mode is different from the first transmission mode.

9. A control system for cache placement of base station, comprising:
a popularity generator configured for obtaining a dynamic moving information of a mobile device, and determining a popularity of a file according to the dynamic moving information of the mobile device;
a cache placement decision unit configured for determining a cache placement of at least one base station according to the popularity; and
a cache update controller configured for transmitting the file to the at least one base station according to cache placement for the mobile device to download.

10. The control system of claim 9, wherein the popularity generator is further configured for obtaining a transmission channel state information of the at least one base station corresponding to the dynamic moving information of the mobile device;
wherein the popularity generator determines the popularity of the file according to the dynamic moving information of the mobile device and the transmission channel state information of the at least one base station.

11. The control system of claim 10, wherein the cache update controller transmits the file to a cache unit of the mobile device before the mobile device enters a service cell with poor channel or poor network environment indicated by the transmission channel state information according to the dynamic moving information of the mobile device and the transmission channel state information of the at least one base station.

12. The control system of claim 9, wherein the dynamic moving information comprises a known mobile device route.

13. The control system of claim 9, wherein the popularity generator determines the popularity according to the dynamic moving information of the mobile device and a probability that the mobile device downloads the file in at least one service cell corresponding to the at least one base station.

14. The control system of claim 9, wherein the cache update controller responds to a first file download request of the mobile device, and determines a first transmission mode of the at least one base station to the mobile device according to a cache state of the at least one base station, wherein the at least one base station transmits the file to the mobile device in the first transmission mode.

15. The control system of claim 14, wherein the first transmission mode is one of a joint transmission mode and a coordinated beamforming mode, wherein when the cache states of the at least two base stations corresponding to a current location of the mobile device show that the at least two base stations store the file, the first transmission mode is the joint transmission mode.

16. The control system of claim 14, wherein the cache update controller further responds to a second file download request of another mobile device, and determines a second transmission mode of the at least one base station to the another mobile device according to the cache state of the at least one base station, wherein the at least one base station transmits the file to the another mobile device in the second transmission mode, wherein the second transmission mode is different from the first transmission mode.

17. A method for controlling a base station to transmit file, comprising:
receiving a cache placement, wherein the cache placement is generated according to a dynamic moving information of a mobile device;
downloading at least one cache file according to the cache placement;
storing the at least one cache file in a cache unit of the base station;
receiving a first file download request; and
performing a file transmission in a first transmission mode or a second transmission mode according to the first file download request and a cache state of the cache unit.

18. The method of claim 17, wherein the step of performing a file transmission in the first transmission mode or the second transmission mode according to the first file download request and the cache state of the cache unit comprises:
transmitting the first file download request and the cache state of the cache unit to a central unit;
receiving a transmission mode control signal, wherein the transmission mode control signal is determined according to the first file download request and the cache state; and
performing the file transmission in the first transmission mode or the second transmission mode according to the transmission mode control signal.

19. The method of claim 17, wherein the step of performing the file transmission comprises:
transmitting the at least one cache file to the mobile device when the at least one cache file is the file requested to download by the first file download request; and
downloading and transmitting another file to the mobile device when the at least one cache file is not the file requested to download by the first file download request.

20. The method of claim 19, wherein the step of performing the file transmission further comprises:
storing the another file in the cache unit of the base station.

21. The method of claim 17, further comprising:
receiving a mobile device location information and a service quality information of the mobile device; and
transmitting the mobile device location information and the service quality information to a central unit;
wherein the mobile device location information is configured for updating the dynamic moving information of the mobile device.

22. The method of claim 17, wherein the first transmission mode is a joint transmission mode and the second transmission mode is a coordinated beamforming mode.

23. A base station, comprising:
a receiving unit configured for receiving a cache placement and a first file download request, wherein the cache placement is generated according to a dynamic moving information of a mobile device;
a download unit configured for downloading at least one cache file according to the cache placement;
a cache unit configured for storing the at least one cache file;
a transmission unit configured for performing a file transmission in a first transmission mode or a second transmission mode according to the first file download request and a cache state of the cache unit.

24. The base station of claim 23, wherein the transmission unit is further configured for transmitting the first file download request and the cache state of the cache unit to a central unit, receiving a transmission mode control signal transmitted from the central unit, and performing the file transmission in the first transmission mode or the second transmission mode according to the transmission mode control signal;
wherein the transmission mode control signal is determined according to the first file download request and the cache state.

25. The base station of claim 23, wherein the transmission unit transmits the at least one cache file to the mobile device when the at least one cache file is the file requested to download by the first file download request, and the download unit downloads another file and the transmission unit transmits the another file to the mobile device when the at least one cache file is not the file requested to download by the first file download request.

26. The base station of claim 25, wherein the cache unit is further configured for storing the another file.

27. The base station of claim 23, wherein the receiving unit is further configured for receiving a mobile device location information and a service quality information of the mobile device, and the transmission unit transmits the mobile device location information and the service quality information to a central unit, wherein the mobile device location information is configured for updating the dynamic moving information of the mobile device.

28. The base station of claim 23, wherein the first transmission mode is a joint transmission mode and the second transmission mode is a coordinated beamforming mode.
